(19) United States
(12) Patent Application Publication
(10) Pub. No.: US 2012/0193912 A1
(43) Pub. Date: Aug. 2, 2012

(54) Thermal Transformer

(75) Inventors: David M Baker, Mosinee, WI (US); Fred P. Lane, Mosinee, WI (US)

(73) Assignee: PDM SOLAR INC., Wausau, WI (US)

(21) Appl. No.: 13/499,702

(22) PCT Filed: Oct. 6, 2010
(86) PCT No.: PCT/US10/51667

§ 371 Date: Apr. 1, 2012

Related U.S. Application Data
(60) Provisional application No. 61/249,062, filed on Oct. 6, 2009.
(60) Provisional application No. 61/252,210, filed on Oct. 16, 2009.
(60) Provisional application No. 61/252,667, filed on Oct. 17, 2009.
(60) Provisional application No. 61/252,668, filed on Oct. 17, 2009.
(60) Provisional application No. 61/376,927, filed on Aug. 25, 2010.
(60) Provisional application No. 61/377,150, filed on Aug. 26, 2010.

(51) Int. Cl. F24J 2/00; F24J 2/40; H02K 7/18; F25B 9/00

(52) U.S. Cl. 290/2; 62/6; 126/572; 126/714

(57) ABSTRACT

A system for providing a thermal transformer to provide heating and cooling to enclosed structures, most generally a building using solar power combined with geothermal storage and a heat powered heat pump to raise or lower the temperature of the stored energy to a useful temperature as needed. The system also has an electrical generation embodiment to provide electricity in addition to the heating and cooling. The system will collect and store solar energy and supply heated or cooled water to the building's existing HVAC system while consuming no fossil fuels and emitting no greenhouse gases. The system may also be used in one embodiment to supply power for the pumps/fans used to circulate the heated or cooled air or water throughout the building.

### CROSS REFERENCE TO RELATED APPLICATIONS

This application claims priority from U.S. provisional applications Nos. 61/249,062 filed 6 Oct. 2009 61/252,210 filed 16 Oct. 2009, 61/377,150 filed 26 Aug. 2010, 61/252,667 filed 17 Oct. 2009, 61/252,668 filed 17 Oct. 2009 and 61/376,927 filed 26 Aug. 2010; the entire contents of each of these applications being hereby incorporated by reference and for which benefit of the earliest priority date is claimed.

### FIELD OF THE INVENTION

The present invention relates to a solar or otherwise low grade thermal energy heat driven apparatus and, more particularly to meeting the energy needs of a structure by means of thermal transformation.

### BACKGROUND OF THE INVENTION

The technology is directed toward a method and apparatus for providing thermal transformation of heat energy by means of a u-tube transformer having a liquid connecting rod between at least two chambers, designated as working chambers. These working chambers can form a system having a high degree of flexibility to function either as a combination of; a heat engine, a heat pump, or a linear electrical generator. In fact, under favorable circumstances, the working chambers could perform the operation(s) of heat pump or heat engine simultaneously with powering a linear electrical generator. In additional embodiments it is anticipated that the u-tube could be bifurcated forming more than two working chambers thus tying more than two working chambers together with a series of liquid connecting rods.

One embodiment of the proposed system will provide heating, cooling and electricity to enclosed structures, most generally a building, using solar power combined with other sources and sinks of thermal energy, such as geothermal storage, tank storage and the like. The thermally generated and stored heat sources and sinks will be used in conjunction with at least one thermal transformer comprising a heat powered working chamber which may act as a heat engine, a heat pump, or a linear electric generator to modulate the temperature hotter, cooler, or provide electricity as needed. The system will collect and store thermal energy and supply heated or cooled fluid, which may be in the form of water or refrigerant, to the structure's existing HVAC or electrical system while consuming no fossil fuels and emitting no greenhouse gasses. The system may also be used in one embodiment to supply power for the pumps and fans used to circulate the heated or cooled fluid (which in these instances can comprise either water, refrigerant, or air) throughout the structure.

One embodiment of the present invention is directed toward apparatus used to air condition an enclosure or provide refrigeration, or provide energy in the form of work from a low grade thermal energy input. More specifically, creating a methodology using a combination of working fluids in a liquid connecting rod system having a heat powered heat engine and heat pump to match properties such as boiling point of the working fluid with the requirements of the working chamber. The objective being the suppression of phase changes, particularly boiling and condensation inside a working chamber.

Another embodiment of the present invention is directed toward adding functionality to combine the functions of climate control of a structure with energy generation under favorable circumstances. More specifically, creating a methodology and apparatus using a combination of working chambers to interchangeably provide the functions of a heat engine, heat pump and electrical generation unit using the fluids in a liquid connecting rod system and a controller to control these system to as needs require.

Examples of applicable systems can include an energy conversion unit typically either designed to provide work from two typically low temperature thermal energy sources with a small temperature difference and/or use the energy from the two low temperature energy sources to raise or lower the temperature to provide heating or cooling.

### SUMMARY OF THE INVENTION

In accordance with the present invention, there is provided a series for examples of applicable systems which can include an energy conversion unit typically either designed to provide work from two typically low temperature thermal energy sources with a small temperature difference and/or use the energy from the two low temperature energy sources to raise or lower the temperature to provide heating or cooling.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a schematic representation of a thermal transformer based system for providing heating and cooling to a structure;

FIG. 2 is a flowchart outlining criteria for several modes of operation of the system;

FIG. 3 illustrates an electrical generation system having the floating piston at top dead center;

FIG. 4 illustrates the electrical generation system of FIG. 3 with the floating piston at the bottom of the stroke;

FIG. 5 provides a schematic representation of a thermal transformer configured in a heat supplementing mode;

FIG. 6 shows an exemplary power stroke and heat pump curves for one embodiment of the present invention.

FIG. 7 shows an exemplary power stroke and heat pump curves for an alternate embodiment of the present invention.

### DETAILED DESCRIPTION

General Principles

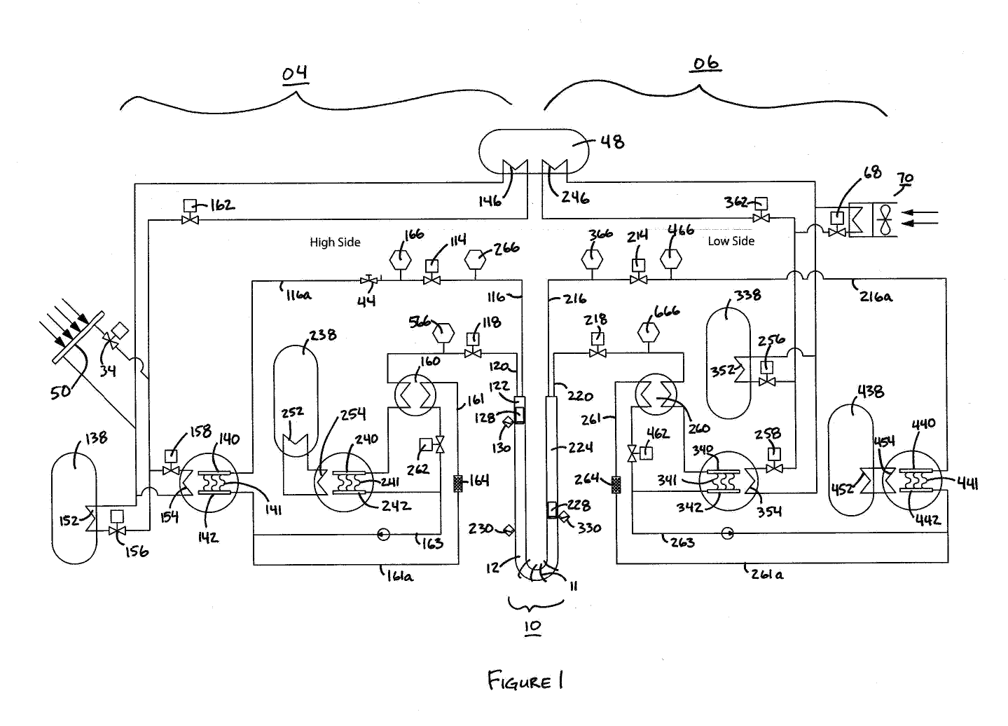

The applicable systems typically comprises thermal transformer (10) which includes a U or J shaped tube as shown in FIG. 1. Also in the example, as can be appreciated by one skilled in the art, general piping for carrying fluid between structures or elements are shown as lines between schematically represented elements. This example includes two working chambers (122) and (224), however those skilled in the art can appreciate that more working chambers using the same principles can also be provided. In this embodiment, either working chamber (122) or (224) can be configured and used as a heat engine with the other chamber used as a heat pump as conditions require. The working chambers can also accomplish thermal transformation when configured as a compressor expander as taught in U.S. application Ser. No. 12/517,421 and PCT/US08/83,192 entitled “Vapor Compression and Expansion Air Conditioner”; the disclosure of which is incorporated herein by reference.

A liquid connecting rod (LCR) (12), typically comprised of an incompressible fluid, is operatively connected between the chambers. It is preferred that the LCR (12) is formed from a low viscosity fluid and arranged such that there is very little or no mixing between the LCR (12) and the working fluid (not shown in this figure) of the working chambers (122) and (224). A fluid such as water, or water mixed with ethylene glycol have typically been used in the prior art as a LCR (12). Several suitable choices can be found to provide a LCR (12) of the stated characteristics such as; mineral oils, aryl benzene compounds, esters such as polyol ester. A suitable material for a LCR (12) should form a liquid having an extremely low fugacity or vapor pressure at the expected working conditions. In this case polyol ester (POE), also commonly found as refrigerant lubricating fluid, is preferred as it suppresses mixing between fluids of the various working chambers and condensation in the working chambers (122) (224). POE such as that provided by NuCalgon has a boiling point well above the expected working temperatures of the working chambers (122) (224).

A series of floating pistons (128) and (228) being of solid construction, and preferably sealed to the walls of the working chamber, is preferably provided to further block mixing between of fluids between the LCR (12) and the working chambers (122) (224). Additionally the pistons (128) (224) and (226) can be formed from a material which can be detected by sensors (130) (230) and (330), which are illustrative of other sensors which can also be placed in other representative positions as can be appreciated by one skilled in the art, and used to control the operations of valves for controlling flow throughout the system. In this system metal pistons were chosen with magnetic sensors installed.

A series of valves (114) (214) (118) (218) are chosen to control the flow into and out of the working chambers (122) (224). The specifics of the flow depend upon the mode of operation of the system. More regarding the specific operation of the valves will follow with more specific examples.

A plurality of pressure or temperature sensors (166) (266) (366) (466) (566) (666) are positioned in key locations with regard to working chambers (122) (224) (226) and valves (114) (214) (118) (218) in order to provide feedback regarding the system for control during operation. Those skilled in the art will appreciate that the working fluids, which can be chosen from a wide variety of suitable fluids such as water vapor, or water mixed with ethylene glycol in vapor form, HVAC refrigerants and the like are. In these embodiments working fluids are preferred to be chosen from the group of HVAC refrigerants. And in this case preferably hydrofluorocarbons (HFC's). More particularly in warmer climates a combination of R-245 can be used on the high side (04) of the system separated by the LCR(12) from the low side (06) with R-134A being used on the low side (06). In cooler climates a mixture of R-236FA may be used on the high side (04) and R-134A or R-123 used on the low side (06). The significance of the high side (04) and the low side (06) will later be made clear by the specific embodiment examples below. Wither one skilled in the art chooses to use a pressure or a temperature sensor may be a matter of choice as the pressure/temperature characteristics for the anticipated range of working fluids are generally well understood by the various thermodynamic gas laws.

Further, one skilled in the art can appreciate that the specific choice of working fluid should be selected by the expected environmental conditions of the system and objectives of the system of matching energy between working chambers and the substantial elimination of condensation of the working chambers. A preferred embodiment can also include dryers (164) (264) being appropriately placed to collect and remove any water moisture which may find its way into the refrigerant loops. Commercially available dryers commonly used in A/C systems are acceptable.

A general consideration for the design of these systems is that HVAC refrigerants are relatively expensive compared with a water based carrier, therefore should be confined in volume.

The system is provided with several reservoirs (138) (238) (338) and (438); for supplying or receiving heat energy, for extracting work or heat for use by the system. Those skilled in the art will appreciate that the energy stored, commonly referred to as “Q” is a function of the temperature “T”, mass “M”, and heat retention capacities “Cp” of the material stored in the reservoir. Further that the energy extracted in the form of heat or work are a function of the ΔT between the reservoirs and the abilities of the respective heat exchangers (152) (252) (352) and (452) to transfer heat into the respective working fluid(s) of the system. Therefore each reservoir should be sized and supplied with sufficient mass to sustain operation under the circumstances and conditions of operation. HVAC refrigerants are relatively expensive and should be kept in the thermal transformer (10) loop and not the thermal reservoirs (138) (238) (338) (438) with corresponding piping. Suitable mass for the thermal reservoir typically comprises a liquid water or water with ethylene glycol mixture. Further the heat exchangers (152) (252) (352) (452) (254) (454) (146) (246) deployed in the system can be of standard; parallel plate, tube in shell, A frame, coils, or tube and fin embodiments commonly found in the art. The preheat or super heater heat exchangers (160) (260) should incorporate or accommodate counter-flow or multi-pass design principles.

First Embodiment Structural Heating and Cooling System

For example a heating and cooling system for a structure is provided. A typical structure (48) may be a building having a heat energy demand of 0.62 kW/2F with a base temperature of 65° F. A solar collection system (50) consisting of 40 flat panel solar collectors each measuring approximately 3 ft by 28 ft with a 44² fixed tilt (in approximately 45² geographic latitude) and having and approximate total area requirement of 8960 ft² is provided.

A reservoir (138) for storing high temperature thermal energy in the form of a 4000 gallon tank of water with temperatures between approximately 95° F. and 125° F. is provided. The range of temperatures for reservoir (138) can be expected to reach between 80° F. and 150° F. or higher. As will become apparent, some sources for providing Q into the reservoir (138) can derive from the solar collection system (50) and alternatively or concurrently with the action of a heat pump derived from one configuration of the working chamber (122). As those skilled in the art will recognize, the solar collection (50) system can also be replaced or supplemented with another suitable source such as a geothermal field or spring, other source of thermal energy.

A reservoir (338) for storing low temperature thermal energy in the form of a 4000 gallon tank of water or water mixed with antifreeze with temperatures between approximately 32²F and 45° F. is also provided. The range of temperatures for reservoir (338) can be expected to reach 50° F. and O° F. Some sources for providing Q, or more rigorously negative Q, into the reservoir (338) can derive from an environmental exchanger (70), such as an air heat exchanger exposed to a low temperature source of air or equivalent, and alternatively or concurrently with the action of a heat pump derived from one configuration of the working chamber (224) further configured to provide cooling in the expander mode. Again further clarification will come from the embodiment examples below.

Reservoirs (238) and (438) are typically maintained at a temperature of about 60° F. and 80° F. But the given temperature can be suitable for operation of the thermal transformer (10) as long as a ΔT, also commonly referred to as differential temperature, of 30° F. or greater is maintained between reservoirs (138) and (238) and between reservoirs (338) and (438). Thus a temperature range of 30° F. and 120° F. can be accommodated depending upon use conditions. Further, the mass of the reservoirs (238) and (438) can derive from a tank or tanks of water as with (138) and (338) above, or it is preferred that the Q and ΔT be more substantial for (238) and (438). For example reservoirs (238) and (438) can derive from land masses or water wells in the earth. For purposes of the given example a series of 19 bore holes (100 ft deep on 7.4′ centers) located in a series of fractured limestone/sandstone bluffs behind the structure (48) or building can be provided. Heat transfer can be facilitated by means of circulation pumps with several temperature graded heat zones can be derived. The physical manifestation requiring and approximate total area of 1500 ft² of subterraneous space.

Operating Modes

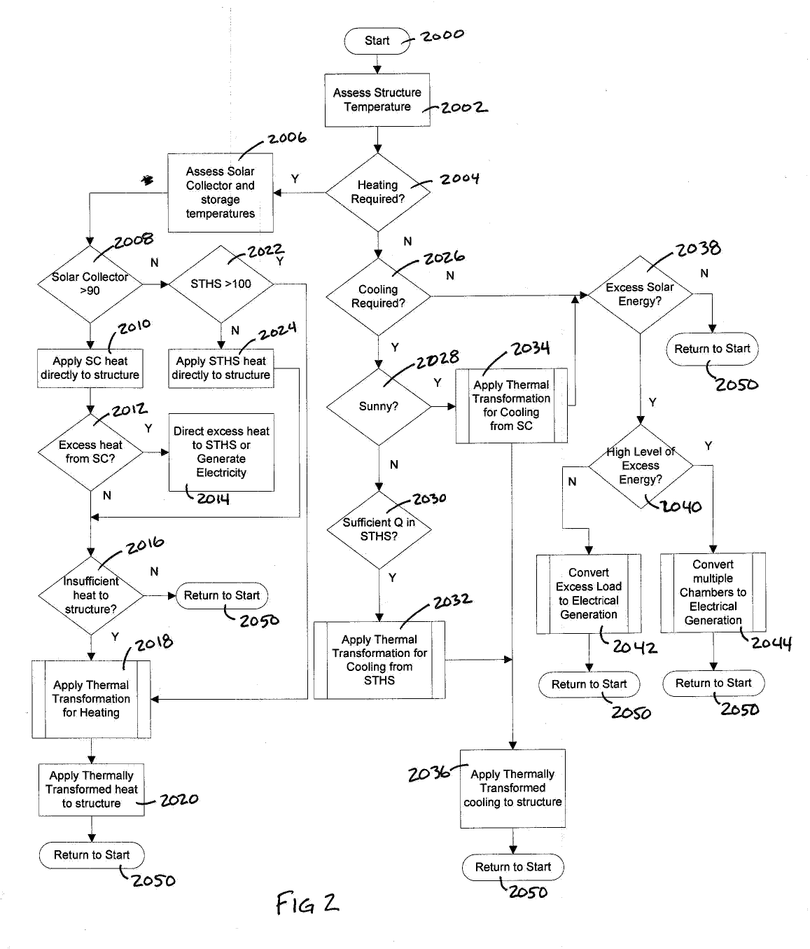

The system as explained can be configured into several configurations or embodiments for the structure such as an in-floor heating system or chilled or heated fluid to a heat exchanger(s) (146) (246) which interfaces with the existing air handling HVAC ductwork to heat or cool the structure (48) or building. As provided in FIG. 2, the system can be operated in a choice of several modes to assess the temperature of the structure (48) and provide for the heating and cooling needs.

Heating is Required

The temperature of the structure is assessed (2002) and it is determined that heading is required (2004). The temperatures of the solar collector (50) and the storage reservoir (138) are assessed (2006). By knowing the mass capacity and thermodynamic properties of the fluids of both the solar collector (50) and the storage reservoir (138), the temperatures can be assessed to determine the available energy or Q available. Choices can then be made to determine the optimal operation.

Solar Collector is Sufficient

In this embodiment, if the temperature of the fluid in the solar collector (50) is above 90° F. (2008) heat can be applied directly from the solar collector (50) directly to the structure (2010). This can be achieved when the solar feed valve (34) and valve (162) are open allowing heated fluid to flow to the structure heat exchanger (146) which is coupled to the structure (48).

If, by predetermined conditions, it is determined that an excess of heat energy from the solar collector (2012) exists, and the temperature of the fluid from the solar collector (50) is greater than the temperature of the fluid in the reservoir (138), the reservoir valve (156) can be opened to add heat to the reservoir (138) by means of the reservoir heat exchanger (152).

In another scenario of excess solar energy (2012), if it is determined that the excess energy can be used to generate electricity, the condenser/evaporator valve (158) can be opened allowing excess heat energy to be added to the condenser/evaporator (141) by means of the heat exchanger (154). The operation of the electrical generator will be explained later.

If it is determined by predetermined conditions that the heat energy from the solar collector is insufficient (2016), the heat energy stored in the reservoir (138) can supplement or be added to that of the solar collector (50). If both are found insufficient, the process of thermal transformation for heating (2018) can be applied in order to generate sufficient heat energy to supplement the system.

Thermal Transformation for Supplementing Heat

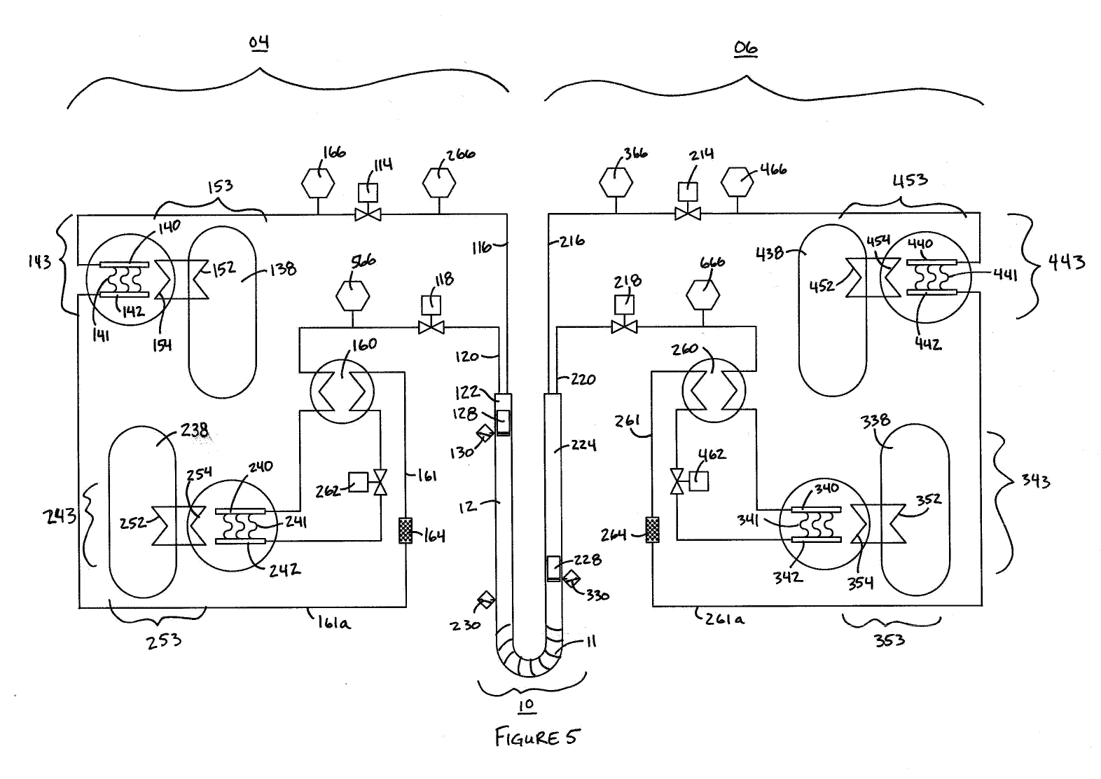

FIGS. 1 and 5 provides a basis for discussing a thermal transformation for supplementing or supplying heat. In general it is preferred that the low side (06) of the system acts as a heat engine, while the high side (04) acts as a heat pump.

Having a reservoir (438) with a substantial heat retention capacity such as a land mass with a complimentary reservoir (338) having a ΔT of 30° F. or greater, the second working chamber (224) is suited to be operated as a low side (06) heat engine.

Working fluid, which in the case of our example comprises R-134A vapor, having received heat energy from reservoir (438) by means of heat exchanger (452) and leaves the condenser/evaporator (441) through the evaporator port (440) and flows toward the high side port (216). The flow is controlled by the high side valve (214) as to be synchronized with the rise and fall of the floating piston (228). The fluid enters the working chamber (224) as the floating piston (228) falls, thus providing work to the floating piston (228) of the working chamber (224) which is transferred through to the LCR (12) causing a corresponding floating piston (128) to rise. Meanwhile in the working chamber (122) a separate working fluid, which in the case of our example comprises R-236FA, which had been drawn from reservoir (238) across a preheater (160) and through valve 118 and corresponding low side port (120) into the working chamber (122) during the preceding intake stroke, having received energy in the form of compression, now exits as a compressed vapor by means of the high side port (116) through valve (114) to flow into the evaporator port (140) where it is condensed releasing its energy into the condenser/evaporator heat exchanger (154) and by means of valve (162) to the structure heat exchanger (146) and into the structure (48).

Alternatively, the flow could be modified to be directed to reservoir (138) by means of reservoir valve (156) and heat exchanger (152) in order to add heat to the reservoir, which then feeds (146).

The routines terminate with a “return to start” (2050) in order to constantly assess the structure temperature (2002) in order to make accommodations in the flow for changing conditions.

Cooling is Required

While those skilled in the art will recognize that there may be several modes suited to providing cooling, it is preferred that the high side (04) be operated as a heat engine, and that the low side (06) be operated as a compressor/expander style heat pump.

The temperature of the structure is assessed (2002) and it is determined that heating is not required (2004) and that cooling is required.

For the purposes of this disclosure, there can be two modes of operation to choose from, slow mode or fast mode. The discussion of these modes is provided below circa [00096], and will not be given here.

Energy for Electrical Generation is Available

At several decision points in the flow (2014) (2038) (2040) it can be determined that excess heat energy exists in order to provide electrical generation. The present disclosure comprises an inventive improvement on the generation system as taught in U.S. application Ser. No. 11/387,405 evolving into U.S. Pat. No. 7,748,219 entitled “Method and Apparatus to Convert Low Temperature Thermal Energy to Electricity” and corresponding PCT/US06/102440; the disclosure of which is incorporated by reference.

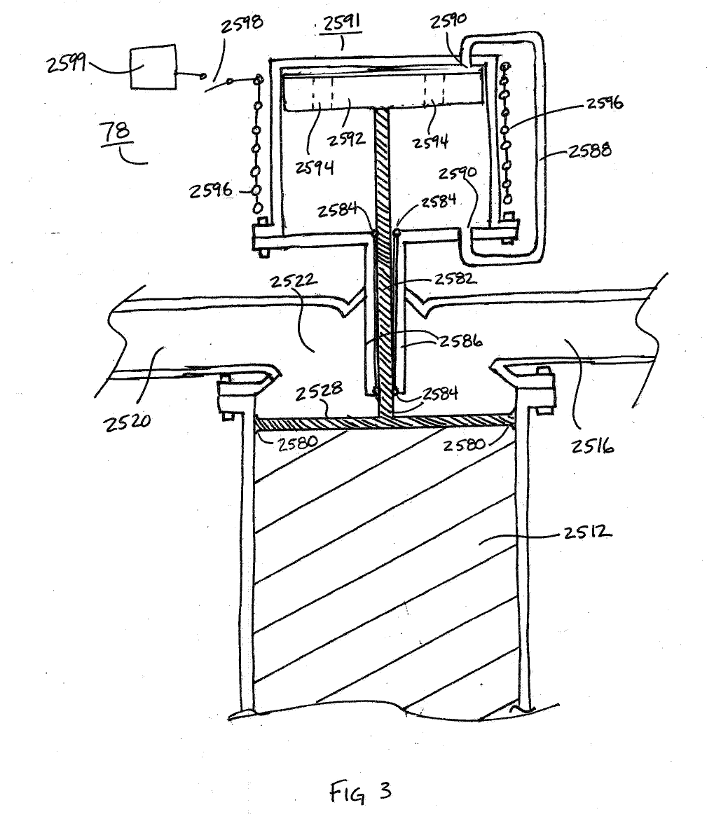

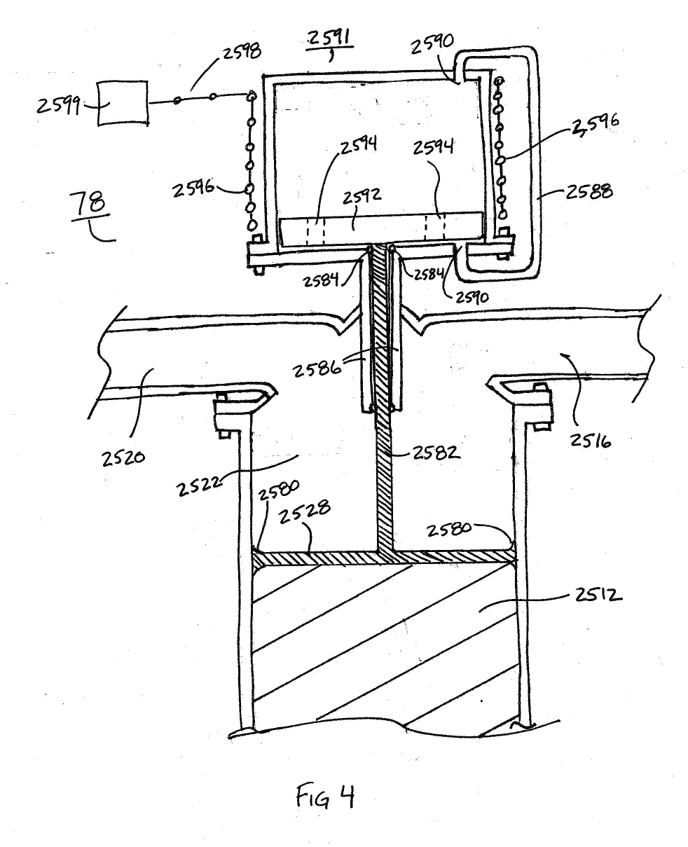

FIGS. 3 and 4 teach a dual use working chamber wherein a chamber (2522) is fashioned after chambers (122) and/or (224) and having several modifications in order to provide electricity by means of a linear generator for example. which in one instance can provide electricity from the working chamber. In another embodiment or mode of operation the working chamber (2522) could be used to provide both thermal transformation and electricity simultaneously.

A thermal transformer (10) is provided with at least two working chambers of the type shown in FIGS. 3 and 4 (2522). There are provided a low side port (2520) and a high side port (2516) having the flow controlled by valves (not shown), but fashioned after valves (114) (214) (118) (218) shown in FIG. 1. As with other working chambers, (2522) can be formed with generally cylindrical walls having a top and forming a defined volume. The actual volume being variable due to a sliding floating piston (2528) which is of generally solid construction and receiving work from and working upon a liquid connecting rod (2512) (LCR).

In this instance it is preferred that the floating piston (2528) further comprises a slidable seal (2580) conforming closely to the walls of the chamber (2522) in such a manner as to hermetically seal as far as practical the LCR (2512) from the contents of the working chamber (2522) to allow work done between the floating piston (2528) and the working chamber (2522) to be as efficient as possible. This will allow the floating piston (2528) to serve as a platform to facilitate the transfer work between the liquid connecting rod (2512) and a solid connecting rod (2582) which is firmly connected to the floating piston.

An o-ring, or other suitable and slidable seal, such as (2584) can be located at the entrance and exit points of the guide sleeve (2586) to minimize points of contact, and therefore friction as the solid connecting rod (2582) slides up and down across the stationary seals (2584). The seals (2584) also provide way to keep pressure changes developed in the working chambers (2522) from bleeding off into the linear generator (78). The guide sleeve (2586) should be oriented such that the rise and fall of the LCR (2512) results in a linear motion of the solid connecting rod (2582).

A magnetic member (2592) is firmly attached at the opposing end of the solid connecting rod (2582) from the floating piston (2528). The magnetic member (2592) generally in the form of a magnetic disk, is provided with a housing (2591) which serves to contain the member (2592) and serve as a seal for any refrigerant vapors which may find their way into the housing (2591). It is preferred that the outer edges of the magnetic member (2592) be as closely situated with the side or vertical walls of the housing (2591) in order to maximize electromagnetic coupling with the coupling coils (2596). The coupling coils (2596) being of conductive material such as copper wiring, in order to generate electricity from the movement of the magnetic member (2592).

Having the magnetic member (2592) inside the housing (2591) with close proximity to the walls can cause resistance in the form of pressure differential as the magnetic member (2592) moves in a linearly reciprocating fashion. Therefore several means can be employed to relieve such pressure differentials. A bypass (2588) can be formed between an upper and a lower orifice (2590) located in the roof and floor of the housing (2591). Preferably, a series of relief vias (2594) can be formed in the body of the magnetic member (2592) being sufficient to eliminate pressure differential formation as the member (2592) moves about.

In operation a starting point of having the floating piston (2528) at top dead center, as shown in FIG. 3, is provided. The working chamber (2522) having been evacuated by the upward stroke of the LCR (2512), and the magnetic member (2592) situated substantially at the top of the housing (2591) and in strongest electromagnetic coupling with the top coupling coils (2596). A valve opens providing heat energy input in the form of vapor pressure through a high side port (2516) resulting in a downward motive force on the floating piston (2528). As the floating piston (2528) moves downward, the solid connecting rod (2582) serves to pull the magnetic member (2592) downward generating an electromotive force on the coupling coils (2596) thus creating electricity.

Once the floating piston (2528) reaches the bottom of the stroke, as shown in FIG. 4, the working chamber on an alternative end of the LCR (2512) supplies a motive force causing the LCR (2512) to reciprocally rise. A valve in communication with the low side port (2520) is then opened exhausting the accumulated vapor. The solid connecting rod (2582) pushes the magnetic member (2592) upward generating an electromotive force of the opposite sign.

For simplicity, it is anticipated that the magnetic member (2592) will be continuously attached to, and move with, the floating piston. A switch (2598) can therefore be provided for coupling the coupling coil (2596) with a load (2599). As shown in FIG. 3 the switch (2598) can be opened, or as shown in FIG. 4, the switch (2598) can be closed. The switches (2598) can be electrical or mechanical by design. The load can be of variable values in order not to overtax the system, or can be a storage vehicle such as batteries, hydrolysis or the like.

In operation there are times of the year (fall and spring for example in northern climates and winter in southern climates) that the structure (48) has minimal or no need for heating or cooling, but still has a need for electricity. At these times the thermal transformer (10) can be configured to operate in electricity only mode wherein both working chambers (122) and (224) can be operated as heat engines to drive a reciprocating electrical generator (78) in the other chamber. Further other ancillary working chambers (226) can be added and dedicated as an electrical generator (78).

Suppression of Boiling and Condensation.

By design the thermal transformer (10) operates best when there is no resulting energy loss due to condensation and subsequent boiling or evaporation of working fluid inside the working chambers (122) (224). The system is comprised generally of a high side (04) component which operates between a relatively high temperature reservoir (138) and a medium temperature reservoir (238). The low side (06) operates between a medium temperature reservoir (338) and a relatively low temperature reservoir (438). As such the temperature range of the high side (04).

Other design elements which can reduce boiling and condensation and eliminate mixing is to form a billows type arrangement inside the working chambers (122) (224) which can seal and separate the LCR fluid from the working fluids.

To help minimize the LCR fluid from boiling as it travels up the cylinder wall, it is preferred to keep the temperature/pressure conditions in the chamber below boiling point of the LCR fluid. While this can be done by control of the chamber (122) (224) temperature and pressure conditions, it is also greatly influenced by the choice of the LCR fluid itself. For example a suitable LCR fluid is a synthetic polyol ester hydrocarbon (POE) with the brand name Premier Care® has a Vapor pressure of <0.001 kPa @25° C. and a boiling point of >570° F. at one atmosphere.

First Working Fluid with LCR

A suitable working fluid which could be chosen for the high side (04) working chamber (122) is a 1,1,1,3,3-pentafluoropropane known as R245fa with a brand name of Genetron® . R245fa has a vapor pressure of ˜1.49 kPa @25° C., nearly 1,500 times that of the polyol ester, and a boiling point of 58.8° F. at one atmosphere. Therefore it would be preferred to keep the conditions of the LCR (12) fluid and the walls of the chamber(s) (122) (224) (226) below 570° F. at one atmosphere, but above the saturation conditions (temperature and pressure) of the R245fa working fluid with a boiling point of ˜60° F. under worst case conditions. A typical worst case for boiling of the LCR (12) being when the piston (128) is at the top of stroke—this is the condition where the chamber is at the highest temperatures due to compression. The pressure of the working fluid should be high enough to suppress the boiling of the LCR fluid. A typical worst case for condensation of the working fluid being when the LCR (12) and piston are at the lowest point of expansion during an expansion stroke. The temperature of the working fluid and the working chamber (122) walls should be kept above the boiling point of the R245fa (60° F. at 1 atm).

Therefore under certain use conditions, it may be advantageous to add heat to the liquid in the LCR (12) to warm the walls of the working chamber (122) during the upstroke which can inhibit condensation on the down stroke. Heat may be added in the form of a heating tape (11) wrapped or coiled around the U-tube of the thermal transformer (11). In the preferred embodiment up to 700 Watts can suffice depending upon use conditions.

Second Working Fluid with LCR

A suitable working fluid which could be chosen for the low side (06) working chamber (224) is a 1,1,1,2 tetrafluoroethane known as R134a with a brand name of DuPont Suva® . R134a has a vapor pressure of ˜666 kPa @25° C. and a boiling point of −14.9 ° F. at one atmosphere. Therefore it would be preferred to keep the conditions of the LCR (12) fluid and the walls of the chamber (224) or (226) below 570° F. at one atmosphere, which should be easy to do, but above the saturation conditions (temperature and pressure) of the R134a working fluid with a boiling point of −14° F. under worst case conditions. The choice of an R134a working fluid on the low side with a POE LCR(14) give a wide range of latitude for operation of the low side (06) for being suited for interface with a low temperature reservoir such as (338).

Energy Matching

Being able to configure the working chambers (122) (224) (226) within the thermal transformer (10) to form either heat engine or heat pump chambers depending upon system requirements allow a chamber configured as a heat engine to provide work energy to the system and a chamber configured as a heat pump to use this work energy to change the thermodynamic characteristics of the heat pump working fluid. The heat engine working fluid, and the heat pump working fluid which is generally compressible, expandable, and with favorable vapor pressure characteristics are matched according to the requirements of the system as is pointed out in provisional patent application No. 61/252,374 entitled “Method and Apparatus to match total energy on power and return strokes between working chambers”, which is also included by reference. The LCR fluid typically comprises a liquid which is incompressible and having a low vapor pressure which separates the working fluids in the working chambers (122) (224) (226). The working fluids of the HE and/or HP can be at various phases of composition but are preferred to substantially be a either saturated or superheated vapor inside the working chambers (122) (224) (226) which is compressible and having a vapor pressure which is matched to the constraints of the various thermal source/sinks (153) (253) (353) (453) of the high side (04) and the low side (06) respectively. Such requirements give some latitude as to the choice of working fluids depending upon the peculiarities of the system, and without departing from the spirit of this invention.

In order to optimize operation of the system, the total energy supplied to the system should equal the total energy used by the system on the power stroke and the total energy supplied to the system should equal the total energy used by the system on the return stroke. For ongoing operation, these energy balances are to be maintained for each individual stroke (power and return), not just for the combination of the power and return stroke. If the balance were not maintained in each direction, the LCR could over or under travel, possibly causing physical damage and affecting the performance and efficiency of the cycle. If the energy balances are maintained in each direction and the cycles form a closed loop, the total energy balance of the entire cycle (power plus return) will be maintained because it is typically related to the individually balanced strokes.

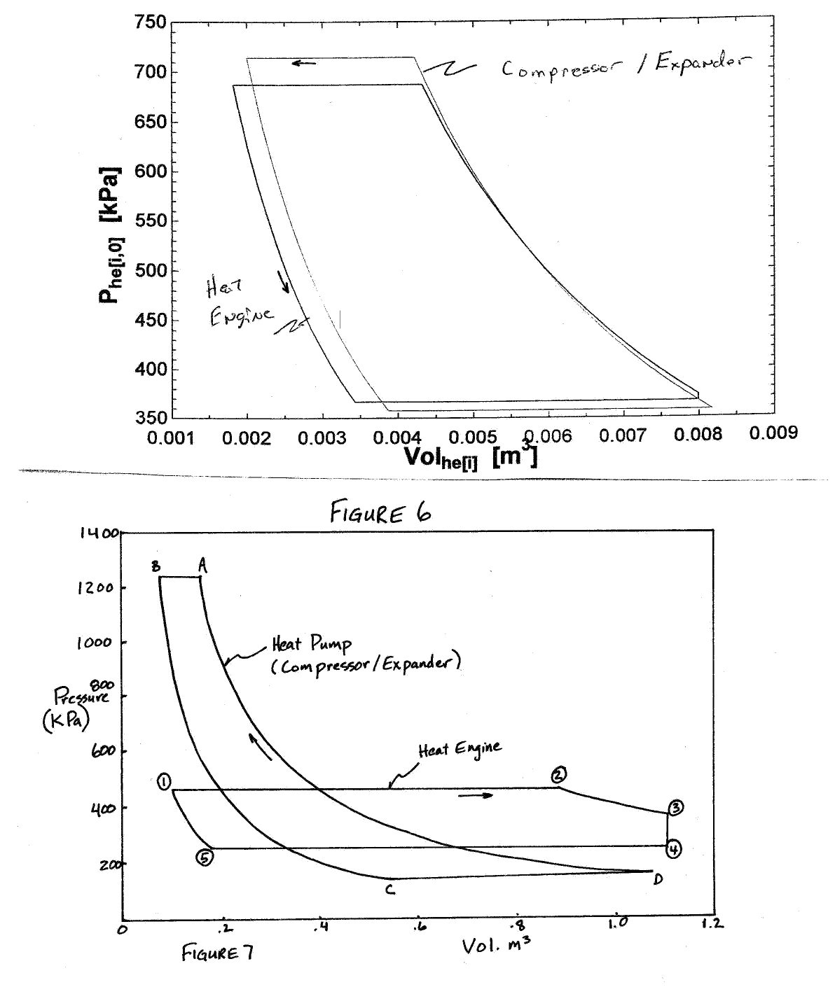

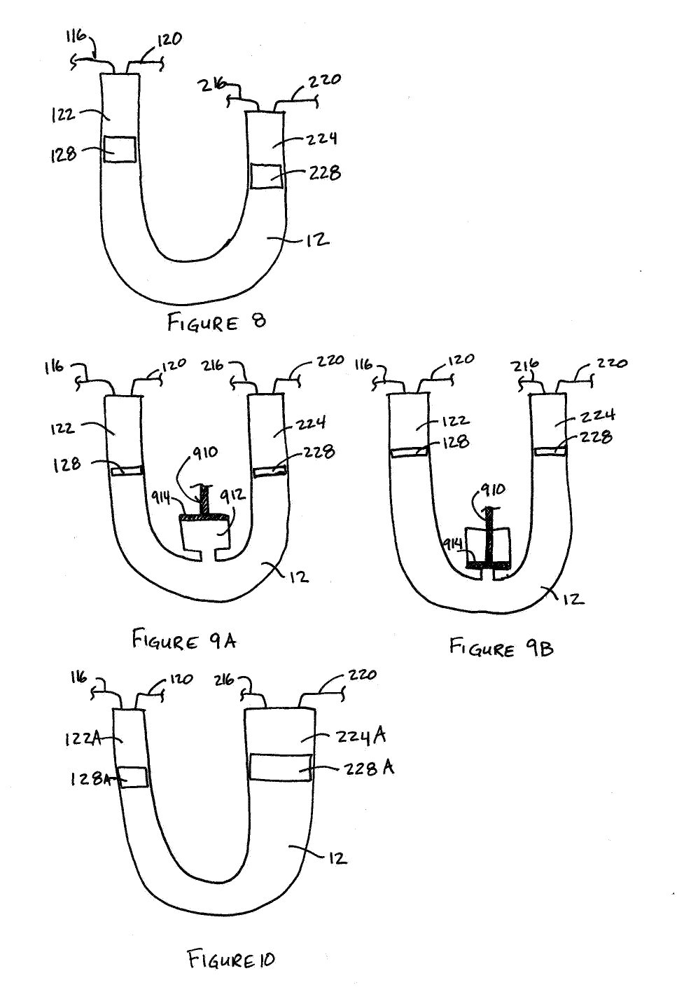

FIGS. 6 and 7 illustrate the principle of energy matching by means of matching the areas under the power stroke and compressor/expander (heat pump) curves. Further, differences between the above curves illustrate that energy matching need not mean that the curves overlap exactly, but that the integral processes are matched.

Referring to the Pressure Volume curve of FIG. 7, the power stroke curve of the heat engine (HE) comprise the curve from point 1 through point 2 and point 3 and ending at point 4 in a clockwise fashion. By means of coupling via the LCR (12) the corresponding compressor/expander or heat pump curve moves counter clockwise from D through point A and ends at point B. During the power stroke, the work energy supplied by the heat engine substantially equals the area under the heat engine curve and the work energy received by the heat pump substantially equals the area under the heat pump curve. In this example the work of the heat engine equals 192.5 kJ and the work of the heat pump equals −192.5 kJ. In general the heat engine should be controlled to supply enough work energy to supply the energy used by the heat pump plus any losses due to friction or heat loss for example, plus provide energy needed to overcome an increase in potential energy or less the amount of energy provided by a decrease in potential energy in the liquid connecting rod for example. This can be an important factor in meeting the requirements of the Fast Mode operation as explained below.

The situation in case of the return stroke is similar by analogy. The return stroke consists of the heat pump curve from point B through point C and ending at point D. The heat engine curve travels from point 4 through point 5 ending at point 1. In this case, the heat pump must supply work energy to the heat engine to match or balance the work energy used by the heat engine plus losses, plus or minus the potential energy removed from or supplied to the system.

It should be obvious to one skilled in the art that if a change in height of the hydrostatic head of the LCT (12) and corresponding floating pistons (128) (228) provides potential energy to the system during the power stroke, the opposite change in height will remove an equal amount of energy from the system during the return stroke. If the change in height removes potential energy from the system during the power stroke, the same amount of potential energy should be available to the system during the return stroke.

When looking to balance or match the energy or work done between the working chambers, there are several parameters of control in the design process. As is shown in FIG. 8 one is to provide a physical height difference, referred to as offset, between working chambers such as between (122) and (224) in order to modulate or change potential energy during the stroke. In one embodiment, if the heat engine chamber is higher for example, the change in potential energy will generally add energy to the system during the power stroke and remove energy from the system during the return stroke due to differences in hydrostatic head caused by the LCR (12). Having different working chamber heights can also change the compression ratios between (122) and (224) for given stroke lengths. If the heat engine chamber is lower, the change in potential energy will generally add energy to the system during the return stroke and remove energy from the system during the power stroke by analogous reasoning.

Another design parameter or embodiment can include varying the amount of liquid in the LCR (12) as shown in FIGS. 9A and 9B. In this embodiment, a container (912) is provided, having a pushrod (910) and a piston (914). The position of the piston (914) can be regulated to provide more or less liquid to the LCR (12) (see 9B). This effect of raising and lowering the LCR (12) can be seen as a spring effect inside the working chambers (122) and (224) creating variable sized working chambers which can be set according to requirements of the system. Further the piston can be modulated up or down in phase with the strokes in order to provide a variable spring effect with regard to power and return strokes.

Yet another embodiment can include varying the diameters of the various working chambers as shown in FIG. 10. Having a smaller diameter working chamber (122A) working in cooperation with a larger diameter chamber (224A) in order to accomplish a hydraulic effect in conjunction with the working chamber operation. Because the total volume change on the heat pump side must equal the total volume change on the heat engine side, if the diameters are different, the expansion ratios will be different.

Energy matching can also be controlled and maintained by adjusting at least one or several of a selection of operating parameters, either individually or in combination. Operating parameters including working fluid selection, heat engine differential pressure drop (pressure drop from point 3 to point 4 on the heat engine curve which is a function of valve timing), and heat engine and heat pump expansion ratio.

The selection of different working fluids for the heat engine and heat pump has already been discussed and can also be useful in matching the energy balance while providing a temperature shift between the heat engine conditions and heat pump conditions to allow heating or cooling to occur. For example, the high side (04) having R236fa and low side (06) having R134a in their respective working chambers.

The methods can also provide for the use of a single fluid or a mixture of fluids in either of the working chambers, which typically comprise at least one heat engine and/or at least heat pump chamber to assist in achieving the energy balance and matching the desired input and discharge temperatures. By using a mixture of refrigerants (typically non-azeotropic) in conjunction with adjusting the expansion ratio, the work energy can be adjusted at design time as described below to provide the required balance. Secondly, by using the properties of fluid mixtures and distillation techniques, the mixture in each side can be changed automatically by the control system to adjust for varying ambient temperatures and output conditions, for example between use as a heat pump during the winter and use as an air conditioning system in the summer. As the fluid leaving the evaporator is comprised of a saturated or super heated vapor, the vapor pressure in the evaporator can give a good indication of the mass ratio or mixture flowing in the system.

In at least one embodiment, the partial vapor pressure of each fluid in a mixture at a given temperature will differ from the vapor pressure of the pure fluid. For most typical conditions and refrigerants (for example R123 & R134a or R245fa & R134a), the actual vapor pressure can be fairly accurately estimated by the use of Raoult's Law, which states that the partial vapor pressure of the fluid above a mixture of fluids is equal to the vapor pressure of the pure fluid at the same temperature multiplied by the molar fraction of the fluid in the liquid mixture. The total pressure of the vapor mixture is the sum of the partial pressures. Thus, the evaporator vapor mass mixture can be determined or controlled by the molar mass fraction of the evaporator liquid combined with the physical properties (vapor pressure as a function of temperature) of the fluid.

In another embodiment of the system, the mass mixture of the fluid in each chamber of the system (heat engine/heat pump) is determined by the mass mixture of the vapor mixture in the corresponding evaporator. Because evaporation, condensation, or boiling of the working fluid does not occur in the heat engine or heat pump chamber, the fluid completes the entire heat engine or heat pump cycle without a substantial change in mass fraction of the working fluid mixture. The mass mixture of the exhaust of working fluid vapor into the condenser will also be substantially the same as that of the evaporator vapor and that in the chamber.

However, once the fluid enters the condenser, the mass mixture of the vapor is anticipated to change as approximated by Raoult's law for the liquid mixture in the condenser. For the system to be in equilibrium, the mass fraction of the liquid mass flowing from the condenser should substantially equal the mass fraction of the vapor mass flowing from the evaporator. One skilled in the art may provide a condenser design to maintain a substantially similar mass fraction in the condensed liquid as in the vapor mass.

In one embodiment, the work supplied or required by the heat engine or the heat pump during the power or return stroke can be adjusted by changing the mass ratio of each fluid. This can be easily accomplished at design time or installation time, but it can also be accomplished during run time in one of several ways. For example, the control system can open or close valves from one of the three points in the system with different mass fraction mixtures (evaporator liquid, evaporator vapor/chamber/condenser liquid, condenser vapor) to allow flow or pump fluid in either direction between the heat engine and heat pump. Alternatively, if these mass fractions are not pure enough to achieve the desired ratios, the condenser or evaporator liquid can be run through a simple distillation process, which would provide nearly pure liquid of the higher boiling point fluid and nearly pure vapor of the lower boiling point fluid, which can then be added to the desired side (heat engine/heat pump) or stored as liquid or vapor in a separate tank if less mass is required in order to achieve the energy balance.

In addition, because the LCR is not fixed in position, L1 of the heat engine and L1 of the heat pump do not need to be equal, making adjustment of the expansion ratio very easy at run time. These positions and corresponding volumes are easily adjustable simply by changing the timing of the intake and exhaust valves, thereby shifting the LCR either towards the heat engine end or the heat pump end. Because V2-V1 for the heat engine must equal V2-V1 for the heat pump, a smaller L1 for the heat engine and larger L1 for the heat pump increases the expansion ratio for the heat engine and decreases the expansion ratio for the heat pump.

Changing the expansion ratio for a fixed set of input and exhaust temperatures and pressures changes the amount of mass that transfers into and out of the chamber to fill the available volume. The work supplied or required is closely related to this mass transfer. Thus, changing the expansion ratio by changing the valve timing and LCR position allows the required energy balance to be achieved during run time to accommodate varying input and exhaust temperatures simply through valve control of the LCR position. In conjunction with this adjustment, the pressure drop in the heat engine cycle (point 3 to 4) can be increased (to provide more work input) or decreased (to provide less work input) as needed to maintain the energy balance. It should be noted that the thermodynamic efficient of the heat engine cycle decreases as the pressure drop in the heat engine cycle is increased

It will be apparent to those skilled in the art that the above embodiments can be used individually and in cooperation with one another as system design parameters. The present disclosure provides various methods and apparatus to allow the energy balance to be more easily achieved at design time and also allows operating adjustments to be made which provide the ability for the energy balance to be more optimally maintained at run time with varying input and discharge temperatures.

Slow Mode and Fast Mode of Operation

In addition to the flow patterns as shown in FIG. 1, various embodiments heat exchangers may be deployed as shown in FIG. 5. This embodiment is a simplified design to isolate the thermal transformer (10) and teach various modes of operation of the heat engine (HE) and heat pump (HP) interaction, and to maximize properties of each. For purposes of this embodiment; the reservoir (138), heat exchanger (152) and heat exchanger (154) operate as a thermal source/sink (153).

Slow Mode General Considerations

In slow mode for air conditioning (AC), the high side (04) can be seen to operate as a heat engine, while the low side (06) can be seen to operate as a heat pump. The thermal source/sink (153) generates a pressure P₁ in the high side (04) working fluid at the evaporator port (140) of the condenser/evaporator (141), which operates as an evaporator for AC usage. The thermal source/sink (453) generates a pressure P₃ in the low side (06) working fluid at the condenser port (442) of the condenser/evaporator (441) which operates as a condenser for AC usage. Thermal source/sink (353) generates a pressure P₄ in the low side (06) working fluid of the condenser/evaporator (341) which functions as an evaporator. Thermal source/sink (253) generates a pressure P₂ in the high side (04) working fluid of the condenser/evaporator (241) which functions as a condenser.

The pressure P₁ is greater than P₃. The pressure P₄ is greater than P₂. The differences in pressure can be small—several psi—just enough to overcome the valve losses, head height pressure, and provide a small acceleration force. A larger ΔP is not a problem as it leads to a combination of a faster cycle (higher acceleration), greater value losses, and greater pressure drop in the evaporator or pressure drop in the condenser during the stroke.

Slow Mode Operation

Starting with the working chamber (122) in Heat Engine (HE) mode with the floating piston (128) at top dead center (TDC), high side valve (114) is opened. The pressure in the working chamber (122) rises and the floating piston moves downward, causing floating piston (228) to rise.

As piston (228) rises pressure in the working chamber (224) increases. When the pressure in chamber (224) increases to be greater than P₃, valve (114) opens. Those skilled in the art may be able to devise a valve system similar to a check valve where the valve opens automatically, causing working fluid (refrigerant) to flow from the working chamber (224) to port (440) of the condenser/evaporator (441).

As piston (128) reaches the bottom of the stroke, valve (114) is closed and travel stops. Under operating conditions, typical pressures for port (440) can be about 75 psi (using R134a) and 90-05 psi for evaporator port (140) (using R236fa).

After the previous stroke is completed, valve (118) is opened allowing flow from the working chamber (122) into the condenser/evaporator (243). When the valve is initially opened the chamber pressure P_{H} for (122) is approximately equal to P3 because a pressure level slightly higher than P₃ was required to exhaust working chamber (224) to port (440).

P₃ is typically substantially higher than P₂ (approximately 75 psi for P₃ vs 25-35 psi for P₂) and this exhaust occurs in a turbulent, non isentropic, and relatively inefficient manner. As refrigerant exhausts through valve (118), the piston (128) moves up and piston (228) moves down drawing from low side port (220) and lowering the pressure P_{L} in chamber (224).

As (P_{L}) drops to be equal to or lower than P₄, valve (218) opens (again following a check valve design) and flow starts through valve (218) from evaporator port (340). Piston (228) continues to drop and piston (128) continues to rise by action of the LCR (12). At the end of stroke, valve (118) closes and travel stops. At the end of this stroke P_{L} is approximately equal to P₄ and P₂ which is typically 25 to 35 psi (for 236fa) and P₄ may be a few psi higher than P₂. The return valve controls the flow of the low side (06) working fluid (typically 134a) from condenser (443) to evaporator (343). Evaporator (343) may comprise only a vapor phase or may have liquid at or near (342) and vapor at (340) by operation of the coils at (341).

As piston (128) arrives back at TDC, the cycle starts again. Since P_{H} is approximately equal to P₂, the initial flow through valve (114) can be seen as non isentropic and initially consists of raising the pressure P_{H} and P_{L} in both chambers (122) (224) to P₃, which can be seen as an inefficiency as it does not extract useful work from the system.

Fast Mode

While the so called slow mode is operational, fast mode provides advantages in terms of operating capacity, efficiency, and capability to use a wider variety of source and sink temperatures (more flexibility). In fast mode, the LCR (12) is accelerated at a relatively high rate (5 to 15 times gravity (g's) is typical) to a high velocity (up to 4 to 5 meters per second) which provides a significant amount of LCR (12) inertia. This inertia provides the ability to create high and low pressures in the chambers (122) or (224) during various portions of the stroke as the kinetic energy of the LCR (12) is converted to potential energy in the pressurized working fluid vapors and gasses. Because an opposing differential pressure and differential force is required to slow and stop the LCR (12), the pressure of the compressing chamber (on either side) (122) or alternatively (224) will be higher and the pressure of the expanding chamber will be lower than it would have been without these inertial effects. Although the fast mode provides a higher efficiency, higher capacity (cooling, heating or electric generation), and more flexibility in source and sink temps, if it also has higher requirements for balance (or energy matching), more rigorous valve design, and a higher level of engine/valve control.

The kinetic energy of the LCR (12) is zero as the LCR (12) changes direction at both ends of the stroke. A condition of operation in a heat engine (HE) to compressor/expander (C/E) configuration is that the work produced by the HE on the power stroke be matched with the work used by the C/E in order to reach the same position at the end of each stroke. Some small variation in the position at the end of stroke is normal and acceptable. The work produced by the HE and the work used by the C/E during the power stroke for the purposes of this explanation don't match exactly, but closely. One reason for some small deviation is because there are forms of potential energy in the system which are different at the beginning and end of stroke. Examples may include the head potential due to the movement of the LCR (12) and potential energy stored in the working fluid vapor in each chamber (122) and (224). The vapor potential energy in each chamber can also change from the beginning of a stroke to end of a stroke.

To account for changes in potential energy, the balance between work in and work out of the thermal transformer (10) should include the changes in the potential energy which can be expressed as W_{HE}=W_{C}/_{E}+ΔPE. A similar discussion is applicable to the return/cooling stroke. The work supplied by the C/E should substantially equal the work required to exhaust the vapor from the HE into the condenser (243) plus any change in PE.

There are several ways to achieve this energy balance as discussed previously. The valve design constraints are tighter for fast mode operation. Additionally valve/engine control should also be tighter in the fast mode. In fast mode cycle rates on the order of 180 to 360 milliseconds can be achieved, so pressure and position sensors (166) (266) (366) (466) (566) (666) (130) (230) (330) should have an approximate 10-15 millisecond time frame for response.

It is preferred that the valves (114) (214) (118) (218) (262) (462) be able to open/close in 20-30 milliseconds. The valves (114) (214) (118) (218) (262) (462) should be sized so that there is minimal pressure drop through the valves during operation. With piston speeds up to 5 meters per second and a cylinder diameter of 100 mm for example in a preferred embodiment, required flow capacity can be significant. For example the above system can require a 1″ diameter or greater intake valve orifice and a 1½″ diameter or greater exhaust valve orifice. Additionally the head design may be tilted as taught in FIGS. 3 and 4 to accommodate larger diameters for flow. Such principles of valve design should enable a satisfactory pressure drop through the valves keeping pressure drops to a few psi. During the end of the strokes when the piston velocity is lower, either as the piston is accelerating from Ø or decelerating to Ø is the primary time when the valves will be open in normal operation as described in the following method of fast mode operation.

Method of Fast Mode Operation

1) After a start-up period of operation the cycle starts at TDC for the HE piston (128), with the given conditions P₍₁₂₂₎ (for working chamber (122)) approximately equal to P₁ and P₍₂₂₄₎ (for working chamber (224)) approximately equal to P₄.

Valve (114) is opened when piston (128) is approximately at TDC and the ΔP=P₁−P₄ causing acceleration of piston (122) downward which gains velocity as piston (228) rises in chamber (224). Fluid continues to flow through valve (114) accelerating piston (128) and maintaining P_{H} slightly below P₁. Before completion of the stroke, valve (114) closes. Inertia keeps the LCR (12) and floating pistons (128) and (228) moving to constrict working chamber (224) which is acting as a C/E. When P_{( 224)} rises to =P₃, valve (214) opens and exhausts fluid to (443).

As piston (228) reaches TDC, P₍₂₂₄₎ approximately equals P₃ and P₍₁₂₂₎ approximately equals P₂. Valve (214) closes and valve (118) opens. The ΔP causes the LCR (12) and pistons (128) and (228) to travel towards the HE impinging upon working chamber (122), exhausting working fluid from chamber (122) to thermal source/sink (243). During the return stroke, valve (118) closes and the LCR (12) and pistons (128) and (228) continue traveling towards the HE because of inertia.

When P₍₂₂₄₎ drops to ≦P4, fluid flows into the C/E chamber (224) from (343) though valve (218). When the LCR/piston reach HE TDC, valve (218) closes and the cycle starts over as piston (128) once again reaches TDC.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

For example those skilled in the art can appreciate that the pressures and valve timings can be altered from those described without altering the essence of the cycle or the spirit of this invention. Further it can be appreciated that the cycles which have been described herein as a method to create cooling my means of the heat pump can be reversed in order to provide heating.

Having thus described the invention, what is desired to be protected by Letters Patent is presented in the subsequent appended claims.

We claim:

1. An apparatus for providing heating and cooling, comprising:
(i) a u-tube thermal transformer comprising, a liquid connecting rod having substantially no vapor pressure at use conditions and at least two working chambers working in reciprocating strokes;
(ii) each working chamber being associated with a different working fluid.

2. The apparatus in accordance with claim 1 wherein the liquid connecting rod derived from the group of; alkyl esters, aryl benzol compounds, polyol ester such as Nucalgon brand, mineral oil or the like.

3. The apparatus in accordance with claim 2 wherein the working fluids are chosen from the class of HVAC refrigerants such as hydrofluorocarbons or HFC's.

4. The apparatus in accordance with claim 3 wherein at least one working chamber functions as a heat engine, and at least one separate working chamber functions as a compressor/expander.

5. The apparatus in accordance with claim 4 wherein the temperature of the liquid connecting rod is maintained above the condensation temperature of the highest temperature working fluid and use conditions of each working chamber is substantially matched to a working fluid in order to minimize condensation of the working fluid on the top bottom and walls inside the corresponding working chamber.

6. The apparatus in accordance with claim 5 wherein the working chambers operate in a slow mode.

7. The apparatus in accordance with claim 5 wherein the reciprocating strokes are matched for work done by the working chamber.

8. The apparatus in accordance with claim 7 wherein the working chambers operate in fast mode.

9. An apparatus and a method for supplying utilities such as; heating, cooling, and or electricity to a structure, comprising:
(i) supplying a solar collection system;
(ii) supplying a high temperature short term thermal storage reservoir for storing thermal energy at a high temperature;
(iii) supplying a low temperature short term thermal storage reservoir for storing thermal energy at a low temperature;
(iv) supplying a medium temperature long term thermal storage reservoir, wherein the temperature of the stored thermal energy is approximately mid-way between the high temperature reservoir and the low temperature reservoir;
(v) providing a thermal transformer comprising at least two working chambers and at least one liquid connecting rod communicating between the chambers;
(vi) the thermal transformer being capable of transforming a medium temperature fluid into a cold fluid for cooling a heat exchanger, or alternately under different conditions transforming a medium temperature fluid into a hot fluid for heating the heat exchanger;
(vii) having a controller for controlling the flow of thermal energy by means of predetermined criteria to provide cooling or heating between the heat exchanger and the structure.

10. The method in accordance with claim 9 wherein the working chambers further comprise a linear electrical generator for providing electricity to the structure.

11. The method in accordance with claim 10 wherein the electrical generator works in conjunction with the heating and cooling functions for providing electricity with heating or cooling simultaneously .

12. The method in accordance with claim 9 wherein the medium temperature thermal reservoir comprises a geothermal storage system.

13. The method in accordance with claim 12 wherein the controller provides instruction for the apparatus to provide a net storage of heat to the medium reservoir in the summer, and a net draw of heat from the medium reservoir in the winter.

14. A system for generating electricity comprising a dual use working chamber in a liquid connecting rod thermal transformer system, comprising:
(i) a thermal transformer having at least two working chambers, the working chambers comprising walls;
(ii) a solid member floating piston being slidably sealed to the walls of the working chamber, the floating piston for providing a platform for transferring work between a liquid connecting rod and a solid connecting rod which is connected to the floating piston;
(iii) the solid connecting rod having a first end and a second end, said first end being firmly attached to said floating piston, said second end being firmly attached to a magnetic member;
(iv) the liquid connecting rod, for reciprocally providing an upward motive force to said solid connecting rod through said floating piston;
(v) a heat energy input, for reciprocally providing a downward motive force, in the form of pressure, on said solid connecting rod through said floating piston;
(vi) an exhaust port, for releasing the pressure on said floating piston, facilitating the piston to ascend;
(vii) the solid connecting rod being coupled with a linear electric generator such that the coordinated efforts of the downwardly motive force and the upwardly motive force coupled with the releasing of pressure causing the solid connecting rod to rise and fall, generating an electromotive force in the linear generator.

15. The system in accordance with claim 14 having a multiple of dual use working chambers coordinated to provide electricity.

16. The system according to claim 14 further comprising a switch for each load.

17. The system in accordance with claim 16 further having a variable electrical load or a battery.

18. The system in accordance with claim 17 wherein the current drain from electricity through the variable load resistor is matched with the excess energy of the system after heating or cooling.

19. A method for matching working fluid properties with working chamber requirements, comprising:
(i) providing a thermal transformer comprising at least one liquid connecting rod being operatively connected with multiple working chambers;
(ii) providing a system whereby a first working chamber is in connection with a high temperature reservoir and with a first medium temperature reservoir through a piping system and a second working chamber is in connection with a low temperature reservoir and a second medium temperature reservoir through a separate piping system;
(iii) determining the conditions of temperatures and pressures created within the working chambers and the piping systems;
(iv) matching the desired properties of a working fluid such as; viscosity, boiling point, vapor pressure, fugacity, and thermal dynamic properties with a corresponding system in order to minimize phase changes in the corresponding working fluid in the system.

20. The method in accordance with claim 19 which also minimizes condensation of the working fluid on the top, bottom and walls of the working chamber.

21. The method in accordance with claim 20 wherein the work from a high molecular weight refrigerant provides cooling through a low molecular weight refrigerant under hot conditions and a low molecular weight refrigerant provides heating through a high molecular weight refrigerant under cold conditions.

22. The method in accordance with claim 22 wherein the system further comprises thermal energy exchangers having gas and liquid phase collectors for operation.
